(19) United States
(12) Patent Application Publication
(10) Pub. No.: US 2014/0173481 A1
(43) Pub. Date: Jun. 19, 2014

(54) HIGHLIGHTING USER INTERFACE

(71) Applicant: KT Corporation, Seongnam-si (KR)

(72) Inventor: Sung Woo KIM, Seoul (KR)

(73) Assignee: KT Corporation, Seongnam-si (KR)

(21) Appl. No.: 14/104,247

(22) Filed: Dec. 12, 2013

(30) Foreign Application Priority Data
Dec. 13, 2012 (KR) 10-2012-0145627

(51) Int. Cl. G06F 3/0484

(52) U.S. Cl. CPC G06F 3/04842
USPC 715/766

(57) ABSTRACT

In one example embodiment, an apparatus includes a display unit configured to: display an image, and display a first highlighting bar and a second highlighting bar on the displayed image; a first highlighting bar controller configured to move the first highlighting bar up or down on the displayed image, based at least in part on a first input instructing a movement of the first highlighting bar; a second highlighting bar controller configured to move the second highlighting bar to left or right on the displayed image, based at least in part on a second input instructing a movement of the second highlighting bar; and an information display unit configured to display information associated with an overlap area in which the first highlighting bar and the second highlighting bar overlap, based at least in part on a third input to select the overlap area.

### TECHNICAL FIELD

The embodiments described herein pertain generally to a user interface (UI) for highlighting an object depicted on a display.

### BACKGROUND

An IPTV (Internet Protocol Television) service provider may provide a service that integrates security of a telecommunication network, content provided by a broadcast television network and features of the Internet; and may further provide voice, data, and video services over one connection simultaneously. Therefore, a user may use a client device to not only make calls, access the Internet, and watch TV, but also enjoy more data, voice, and video integrated services through the IPTV service, serially or in parallel.

### SUMMARY

In one example embodiment, an apparatus includes a display unit configured to: display an image, and display a first highlighting bar and a second highlighting bar on the displayed image; a first highlighting bar controller configured to move the first highlighting bar up or down on the displayed image, based at least in part on a first input instructing a movement of the first highlighting bar; a second highlighting bar controller configured to move the second highlighting bar to left or right on the displayed image, based at least in part on a second input instructing a movement of the second highlighting bar; and an information display unit configured to display information associated with an overlap area in which the first highlighting bar and the second highlighting bar overlap, based at least in part on a third input to select the overlap area.

In another example embodiment, a computer-readable storage medium having thereon computer-executable instructions that, in response to execution, cause one or more processors corresponding to an apparatus to perform operations including: displaying an image; displaying a first highlighting bar and a second highlighting bar on the displayed image; moving the first highlighting bar up or down on the displayed image, based at least in part on a first input instructing a movement of the first highlighting bar; moving the second highlighting bar to left or right on the displayed image, based at least in part on a second input instructing a movement of the second highlighting bar; and displaying information associated with an overlap area in which the first highlighting bar and the second highlighting bar overlap, based at least in part on a third input to select the overlap area.

In yet another example embodiment, a method implemented by an apparatus includes displaying an image; displaying a first highlighting bar and a second highlighting bar on the displayed image; moving the first highlighting bar up or down on the displayed image, based at least in part on a first input instructing a movement of the first highlighting bar; moving the second highlighting bar laterally on the displayed image, based at least in part on a second input instructing a movement of the second highlighting bar; and displaying information associated with the overlap area in which the first highlighting bar and the second highlighting bar overlap, based at least in part on a third input to select the overlap area.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system configuration in which a highlighting user interface may be implemented, in accordance with various embodiments described herein;

FIGS. 2A and 2B show examples of a highlighting user interface, in accordance with various embodiments described herein;

FIGS. 3A and 3B show another example of a highlighting user interface, in accordance with various embodiments described herein;

FIGS. 4A to 4C show still another example of a highlighting user interface, in accordance with various embodiments described herein;

FIGS. 5A to 5C show still another example of a highlighting user interface, in accordance with various embodiments described herein;

FIGS. 6A to 6C show still another example of a highlighting user interface, in accordance with various embodiments described herein;

FIGS. 7A and 7B show still another example of a highlighting user interface, in accordance with various embodiments described herein;

FIGS. 8A to 8C show still another example of a highlighting user interface, in accordance with various embodiments described herein;

FIGS. 9A to 9C show still another example of a highlighting user interface, in accordance with various embodiments described herein;

FIGS. 10A to 10C show still another example of a highlighting user interface, in accordance with various embodiments described herein;

FIGS. 11A to 11C show still another example of a highlighting user interface, in accordance with various embodiments described herein;

FIGS. 12A to 12C show still another example of a highlighting user interface, in accordance with various embodiments described herein;

FIGS. 13A to 13C show still another example of a highlighting user interface, in accordance with various embodiments described herein;

FIGS. 14A to 14C show still another example of a highlighting user interface, in accordance with various embodiments described herein;

FIG. 15 shows an example configuration of an apparatus by which at least portions of a highlighting user interface may be implemented, in accordance with various embodiments described herein;

FIG. 16 shows an example configuration of a display control manager by which at least portions of a highlighting user interface may be implemented, in accordance with various embodiments described herein;

FIG. 17 shows an example processing flow of operations for implementing at least portions of a highlighting user interface, in accordance with various embodiments described herein;

and

FIG. 18 shows an illustrative computing embodiment, in which any of the processes and sub-processes of a highlighting user interface may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

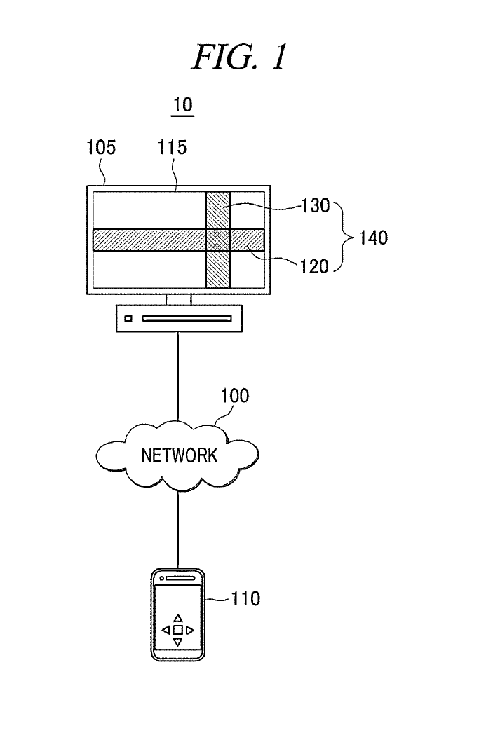

FIG. 1 shows an example system configuration 10 in which a highlighting user interface may be implemented, in accordance with various embodiments described herein. As depicted in FIG. 1, system configuration 10 may include, at least, an apparatus 105 and an end device 110.

Network 100 may refer to a component or module that may be configured to communicatively couple apparatus 105 and end device 110. By way of example, but not limitation, network 100 may include a wired network such as a LAN (Local Area Network), a WAN (Wide Area Network), a VAN (Value Added Network) or the like, or various other wireless network such as a mobile radio communication network including at least one of a 3rd generation (3G) mobile telecommunications network, a 4^{th} or 5th generation mobile telecommunications network, various other mobile telecommunications networks, a satellite network, WiBro (Wireless Broadband Internet), Mobile WiMAX, HSDPA (High Speed Downlink Packet Access), or the like. Alternatively, network 100 may include at least one of a near field communication (NEC), Bluetooth, or peer to peer (P2P) communication protocol.

Apparatus 105 may refer to a television, a smart television, a set-top box that may or may not have a display coupled thereto, a notebook computer, a personal computer, a smart phone, a tablet computer, a phablet device, a game console, or any other type of personal communication terminal that is capable of, at least, receiving and/or playing internet protocol television content. Apparatus 105 may be configured to receive one or more signals that execute control of the operation of apparatus 105 from end device 110 acting as a remote control device for apparatus 105 or from a server that transmits an internet protocol television service to apparatus 105.

Apparatus 105 may be configured to display an image 115 on a display that is part of, or communicatively coupled to, apparatus 105. For example, but not as a limitation, apparatus 105 may be configured to play or reproduce, on the display, internet protocol television content that includes at least one of video-on-demand content, real-time broadcasting content or user interactive content (e.g., games). Image 115 may refer to a frame or a scene included in the internet protocol television content that is played or reproduced by apparatus 105. Further, apparatus 105 may be configured to display a user interface 140 that includes a first highlighting bar 120 and a second highlighting bar 130 on displayed image 115. For example, as depicted in FIG. 1, first highlighting bar 120 may refer to a horizontal highlighting bar and second highlighting bar 130 may refer to a vertical highlighting bar.

End device 110 may refer to a remote controller, a smart phone, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminal that may function as a remote controller that has a remote control user interface including directional keys, a function selection key, alphanumeric keys, channel controller keys, and volume controller keys, etc. End device 110 may be configured to transmit, to apparatus 105 and/or to a server that transmits an internet protocol television service to apparatus 105, one or more signals that implement control of user interface 140 and other operations of apparatus 105. Without using an ordinary pointing means such as a computer mouse, a laser pointer, a touch screen, etc., an object depicted on image 115, which is displayed by apparatus 105, may be designated and/or selected by using user interface 140 that may be controlled by the signals generated by end device 110 having a remote control user interface.

Thus, FIG. 1 shows example system configuration 10 in which one or more embodiments of a highlighting user interface may be implemented, in accordance with various embodiments described herein.

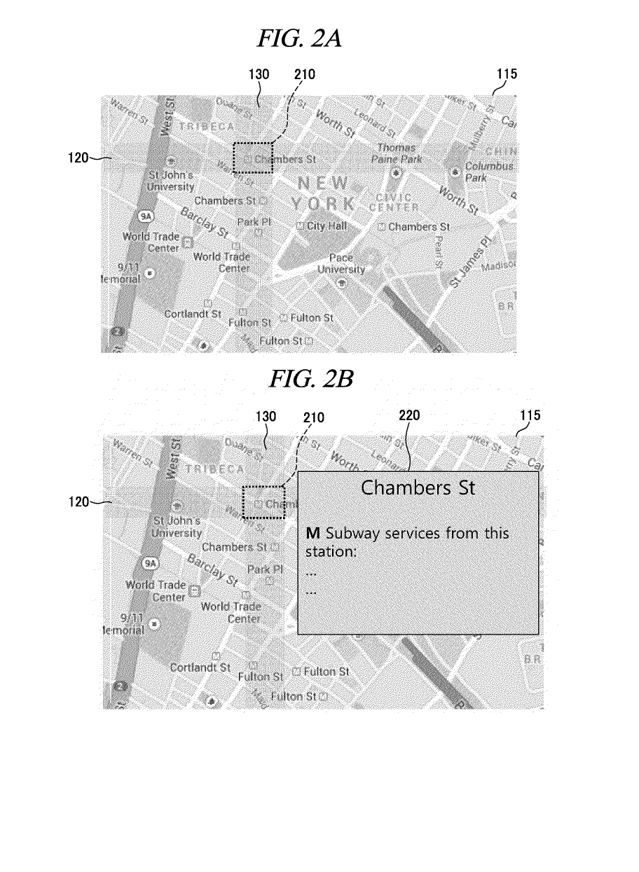

FIGS. 2A and 2B show examples of a highlighting user interface, in accordance with various embodiments described herein.

Apparatus 105 may be configured to display first highlighting bar 120 and second highlighting bar 130 on displayed image 115. For example, but not as a limitation, as depicted in FIG. 2A, image 115 may include a map. Further, an overlap area 210 in which a portion of first highlighting bar 120 and a portion of second highlighting bar 130 overlap may be displayed on image 115. Apparatus 105 may be configured to receive, from end device 110, an input that instructs a movement of first highlighting bar 120 and an input to instruct a movement of second highlighting bar 130. In some embodiments, the inputs to instruct the movements of first highlighting bar 120 and second highlighting bar 130 may be a same input that has multiple components/instructions. In some embodiments, apparatus 105 may be configured to move first highlighting bar 120 up or down on image 115 in accordance with the corresponding received input. Further, apparatus 105 may be configured to move second highlighting bar 130 left or right on image 115 in accordance with the corresponding received input. Accordingly, a position of overlap area 210 on image 115 may be changed concomitantly with the movement of at least one of first highlighting bar 120 and second highlighting bar 130.

Further, apparatus 105 may be configured to receive, from end device 110, an input to select overlap area 210. Apparatus 105 may be configured to then display information 220 associated with selected overlap area 210 on displayed image 115. For example, as depicted in FIG. 2B, information 220 associated with selected overlap area 210 may include a representation of an object within overlap area 210 (e.g., an image, a symbol, an icon or a name of a subway station) and information regarding the object (e.g., a subway departure arrival times at the subway station).

Thus, FIGS. 2A and 2B show examples of a highlighting user interface, in accordance with various embodiments described herein.

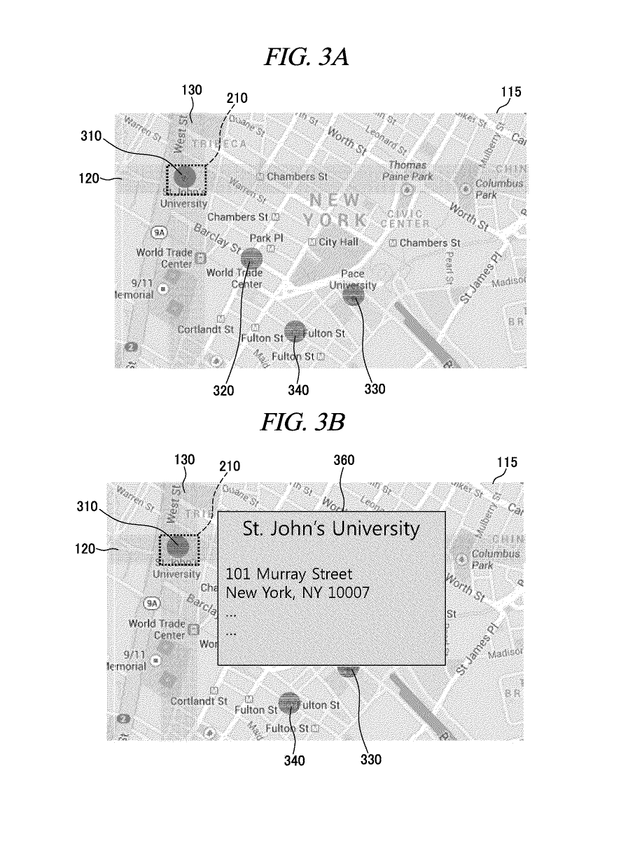

FIGS. 3A and 3B show another example of a highlighting user interface, in accordance with various embodiments described herein.

Apparatus 105 may be configured to display first highlighting bar 120 and second highlighting bar 130 on displayed image 115, and overlap area 210 in which a portion of first highlighting bar 120 and a portion of second highlighting bar 130 overlap may be displayed on image 115. Further, apparatus 105 may be configured to display a representation for each of multiple points of interest (POI) 310, 320, 330 and 340 on displayed image 115. Each of multiple points of interest 310, 320, 330 and 340 may refer to a specific point or location that a user of apparatus 105 may find useful or interesting. For example, but not as a limitation, each of multiple points of interest 310, 320, 330 and 340 may include a hotel, a campsite, a fuel station, a hospital, a bus station, a restaurant, a subway station or any other categories used in navigation systems.

As depicted in FIG. 3B, apparatus 105 may be configured to display information 360 associated with point of interest 310 located in overlap area 210, when a representation of point of interest 310 is displayed on overlap area 210 and apparatus 105 receives, from end device 110, an input to select overlap area 210. For example, point of interest 310 may refer to a hospital, and information 360 associated with point of interest 310 located in overlap area 210 may include a representation of point of interest 310 (e.g., a name of the hospital), information regarding point of interest 310 (e.g., an address or a telephone number of the hospital) and a uniform resource locator (URL) associated with point of interest 310 (e.g., a URL of a web site of the hospital).

Thus, FIGS. 3A and 3B show another example of a highlighting user interface, in accordance with various embodiments described herein.

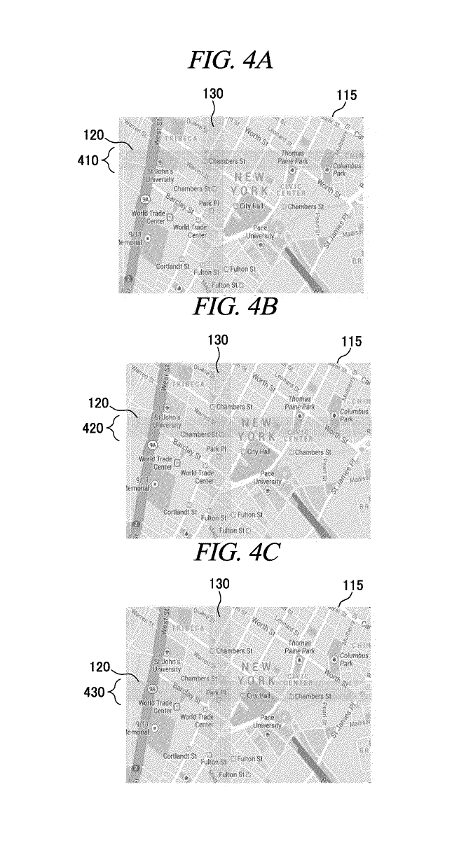

FIGS. 4A to 4C show still another example of a highlighting user interface, in accordance with various embodiments described herein.

As depicted in FIG. 4A, apparatus 105 may be configured to display first highlighting bar 120 and second highlighting bar 130 on displayed image 115. Apparatus 105 may be configured to receive, from end device 110, an input to instruct a movement of first highlighting bar 120. For example, apparatus 105 may be configured to receive the input to instruct first highlighting bar 120 to move up or down on image 115. Apparatus 105 may be configured to then move first highlighting bar 120 up or down in predetermined distance increments, every time apparatus 105 receives the input to instruct first highlighting bar 120 to move up or down on image 115. For example, but not as a limitation, as depicted in FIGS. 4A and 4B, first highlighting bar 120 moves down in increments equal to a height of first highlighting bar 120 from a first position 410 on image 115 to a second position 420 on image 115, when apparatus 105 receives, from end device 110, the input to instruct first highlighting bar 120 to move down. Further, as depicted in FIGS. 4B and 4C, first highlighting bar 120 moves down in increments equal to the height of first highlighting bar 120 from second position 420 on image 115 to a third position 430 on image 115, when apparatus 105 receives, from end device 110, the input one more time.

Thus, FIGS. 4A to 4C show still another example of a highlighting user interface, in accordance with various embodiments described herein.

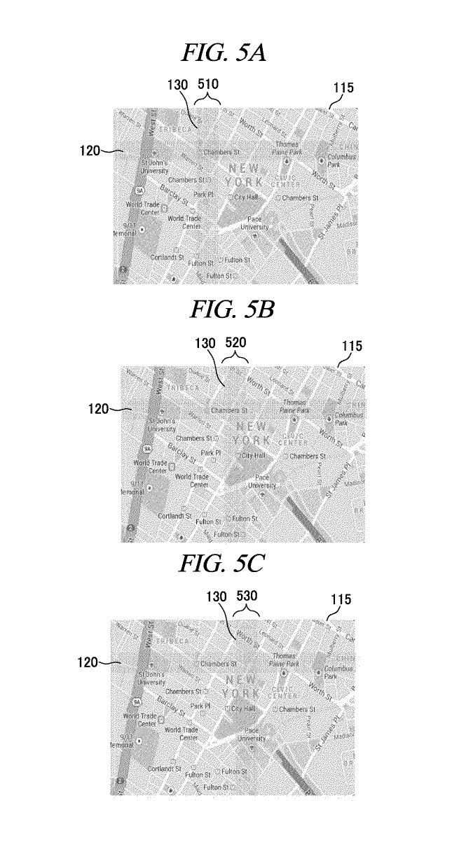

FIGS. 5A to 5C show still another example of a highlighting user interface, in accordance with various embodiments described herein. As depicted in FIG. 5A, apparatus 105 may be configured to display first highlighting bar 120 and second highlighting bar 130 on displayed image 115. Apparatus 105 may be configured to receive, from end device 110, an input to instruct a movement of second highlighting bar 130. For example, apparatus 105 may be configured to receive the input to instruct second highlighting bar 130 to move laterally on image 115. Apparatus 105 may be configured to then move second highlighting bar 130 left or right in predetermined distance increments, every time apparatus 105 receives the input to instruct second highlighting bar 130 to move laterally on image 115. For example, but not as a limitation, as depicted in FIGS. 5A and 5B, second highlighting bar 130 moves right in increments equal to a width of second highlighting bar 130 from a first position 510 on image 115 to a second position 520 on image 115, when apparatus 105 receives, from end device 110, the input to instruct second highlighting bar 130 to move right. Further, as depicted in FIGS. 5B and 5C, second highlighting bar 130 moves right in increments equal to the width of second highlighting bar 130 from second position 520 on image 115 to a third position 530 on image 115, when apparatus 105 receives, from end device 110, the input one more time.

Thus, FIGS. 5A to 5C show still another example of a highlighting user interface, in accordance with various embodiments described herein.

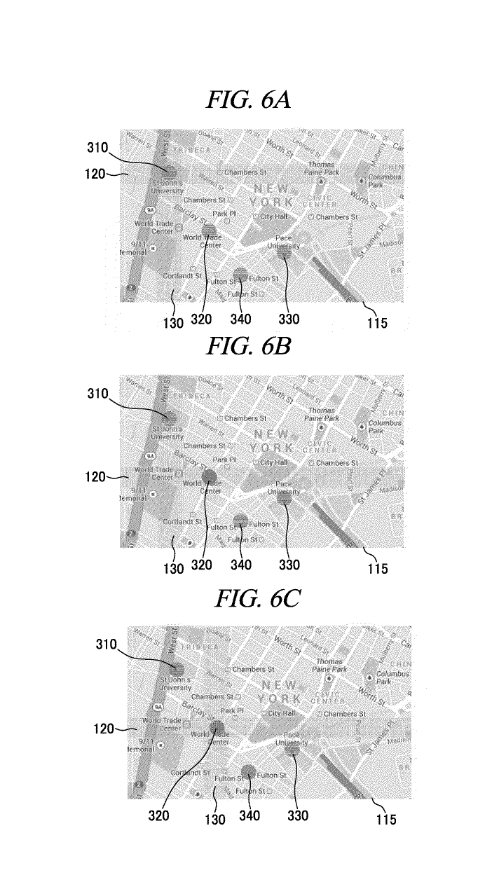

FIGS. 6A to 6C show still another example of a highlighting user interface, in accordance with various embodiments described herein.

Apparatus 105 may be configured to display first highlighting bar 120 and second highlighting bar 130 on displayed image 115. Apparatus 105 may be configured to also display overlap area 210 in which a portion of first highlighting bar 120 and a portion of second highlighting bar 130 overlap on image 115. Further, apparatus 105 may be configured to display a representation for each of multiple points of interest (POI) 310, 320, 330 and 340 on displayed image 115. Further, apparatus 105 may be configured to receive, from end device 110, an input to instruct a movement of first highlighting bar 120. Apparatus 105 may be configured to then move first highlighting bar 120 from a representation of a first point of interest to a representation of a second point of interest. Further, apparatus 105 may be configured to receive, from end device 110, an input to instruct a movement of second highlighting bar 130. Apparatus 105 may be configured to then move second highlighting bar 130 from a representation of a third point of interest to a representation of a fourth point of interest.

For example, but not as a limitation, as depicted in FIGS. 6A and 6B, first highlighting bar 120 may be moved from a representation of point of interest 310 to a representation of point of interest 320, which may be displayed below point of interest 310 on image 115, when apparatus 105 receives, from end device 110, the input to instruct first highlighting bar 120 to move down. Further, as depicted in FIGS. 6B and 6C, second highlighting bar 130 may be moved from the representation of point of interest 310 to the representation of point of interest 320, which may be displayed to the right of point of interest 310 on image 115, when apparatus 105 receives, from end device 110, the input to instruct second highlighting bar 130 to move to the right.

Thus, FIGS. 6A to 6C show still another example of a highlighting user interface, in accordance with various embodiments described herein.

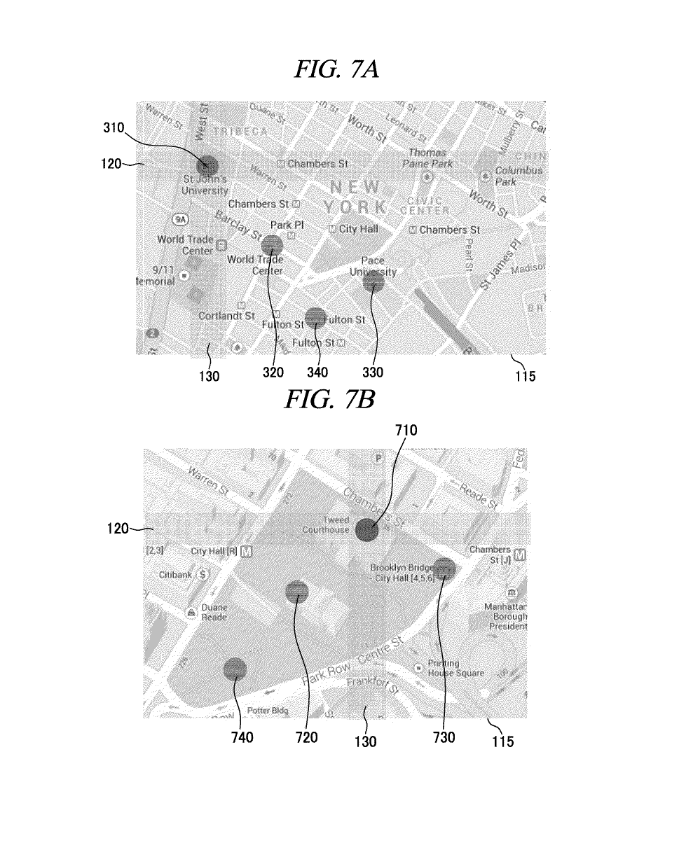

FIGS. 7A and 7B show still another example of a highlighting user interface, in accordance with various embodiments described herein. Apparatus 105 may be configured to display first highlighting bar 120 and second highlighting bar 130 on displayed image 115. Further, apparatus 105 may be configured to display a predetermined range number of points of interest (POI) on image 115. For example, as depicted in FIG. 7A, apparatus 105 may be configured to display the predetermined range number of four points of interest 310, 320, 330 and 340 on image 115.

Apparatus 105 may be further configured to zoom in or zoom out with regard to portions of image 115 based at least in part on a display density of points of interest on image 115. Apparatus 105 may be configured to zoom in on one or more portions of image 115 in order to display the predetermined range number of points of interest on image 115, if more points of interest than the predetermined range number of points of interest are displayed on image 115. Alternatively, apparatus 105 may be configured to zoom out from one or more portions of image 115 in order to display the predetermined range number of points of interest on image 115, if fewer points of interest than the predetermined range number of points of interest are displayed on image 115. So, apparatus 105 may be configured to display the predetermined range number of points of interest in image 115 by zooming in or zooming out with regard to portions of image 115. For example, as depicted in FIG. 7B, apparatus 105 may be configured to zoom in image 115, so that the predetermined range number of four points of interest 710, 720, 730 and 740 are displayed on zoomed-in image 115.

Thus, FIGS. 7A and 7B show still another example of a highlighting user interface, in accordance with various embodiments described herein.

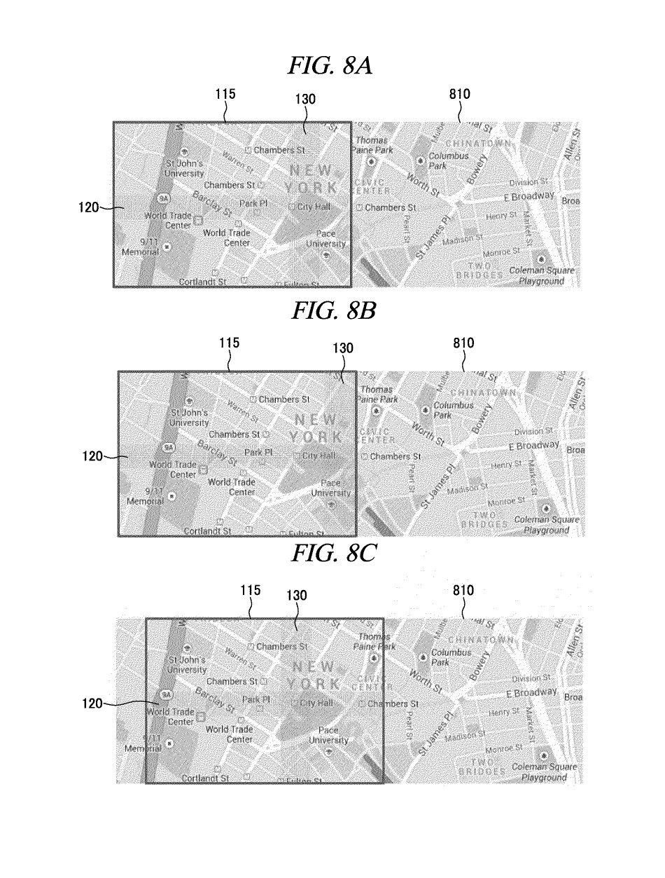

FIGS. 8A to 8C show still another example of a highlighting user interface, in accordance with various embodiments described herein.

Apparatus 105 may be configured to display first highlighting bar 120 and second highlighting bar 130 on displayed image 115. In some embodiments, as depicted in FIG. 8A, image 115 may be a part of a scrollable image 810. Further, apparatus 105 may be configured to move second highlighting bar 130 laterally, i.e., to the left or the right, on image 115, when apparatus 105 receives an input to instruct a movement of second highlighting bar 130. So, second highlighting bar 130 may be positioned at a boundary on the left side of image 115 or a boundary on the right side of image 115. As depicted in the example of FIG. 8B, second highlighting bar 130 is positioned at the boundary on the right side of image 115. Further, apparatus 105 may be configured to scroll image 115 in a direction that is opposite to a direction of the movements of second highlighting bar 130, when apparatus 105 receives the input to instruct second highlighting bar 130, which may positioned at a lateral boundary of image 115 to go beyond a boundary of image 115. For example, as depicted in FIG. 8C, image 115 may be scrolled to the left, when apparatus 105 receives the input to instructs second highlighting bar 130, which is positioned at the boundary on the right side of image 115 to move further to the right.

Thus, FIGS. 8A to 8C show still another example of a highlighting user interface, in accordance with various embodiments described herein.

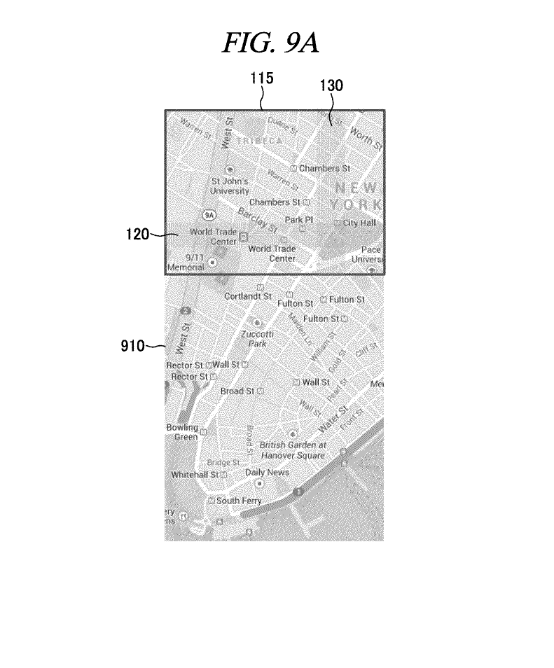

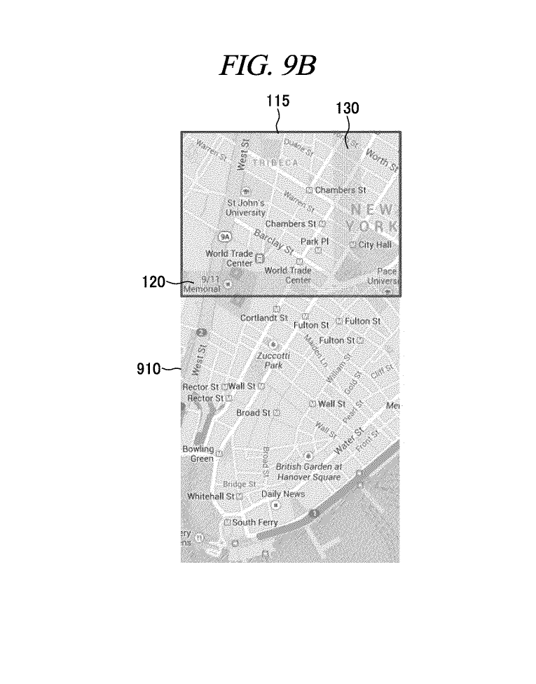

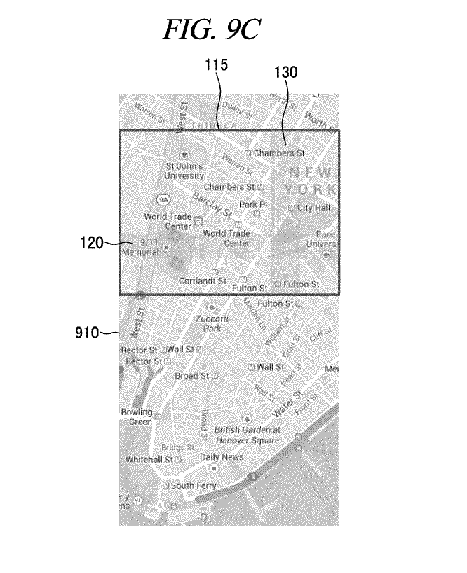

FIGS. 9A to 9C show still another example of a highlighting user interface, in accordance with various embodiments described herein.

Apparatus 105 may be configured to display first highlighting bar 120 and second highlighting bar 130 on displayed image 115. In some embodiments, as depicted in FIG. 9A, image 115 may be a part of a scrollable image 910. Further, apparatus 105 may be configured to move first highlighting bar 120 vertically, i.e., up or down, on image 115, when apparatus 105 receives an input to instruct a movement of first highlighting bar 120. So, first highlighting bar 120 may be positioned at an upper boundary or a lower boundary of image 115. As depicted in the example of FIG. 9B, first highlighting bar 120 may be positioned at a lower boundary of image 115. Further, apparatus 105 may be configured to scroll image 115 in a direction that is opposite to a direction of the movements of first highlighting bar 120, when apparatus 105 receives the input to instruct first highlighting bar 120, which may be positioned at the upper boundary or the lower boundary of image 115 to go beyond a boundary of image 115. For example, as depicted in FIG. 9C, image 115 may be scrolled in an upper direction, when apparatus 105 receives the input to instruct first highlighting bar 120, which may be positioned at the lower boundary of image 115 to move further down.

Thus, FIGS. 9A to 9C show still another example of a highlighting user interface, in accordance with various embodiments described herein.

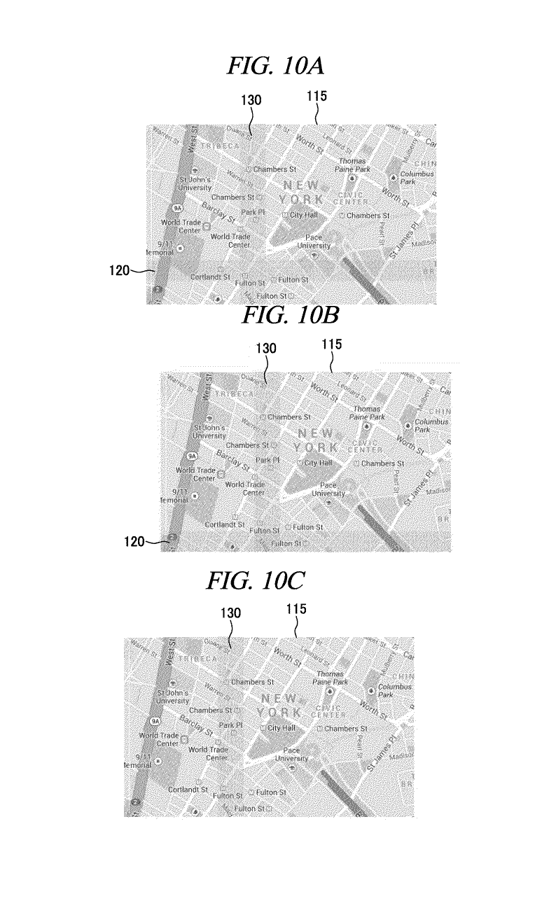

FIGS. 10A to 10C show still another example of a highlighting user interface, in accordance with various embodiments described herein.

As depicted in FIG. 10A, first highlighting bar 120 and second highlighting bar 130 may be displayed on image 115. In some embodiments, image 115 may be a non-scrollable image. Further, apparatus 105 may be configured to move first highlighting bar 120 vertically, i.e., up or down, on image 115, when apparatus 105 receives an input to instruct a movement of first highlighting bar 120. So, first highlighting bar 120 may be positioned at an upper boundary or a lower boundary of image 115. For example, as depicted in FIG. 10B, first highlighting bar 120 may be positioned at a lower boundary of image 115. Further, apparatus 105 may be configured to remove first highlighting bar 120 from image 115, when apparatus 105 receives the input to instruct first highlighting bar 120, which may be positioned at the upper boundary of image 115, to move further upward. Alternatively, apparatus 105 may be configured to remove first highlighting bar 120 from image, when apparatus 105 receives the input that instructs first highlighting bar 120 which is positioned at the lower boundary of image 115 to move further below image 115. For example, as depicted in FIG. 10C, first highlighting bar 120 may be removed from image 115 when apparatus 105 receives the input to instruct first highlighting bar 120, which may be positioned at the lower boundary of image 115, to move even further beyond the lower boundary.

Thus, FIGS. 10A to 10C show still another example of a highlighting user interface, in accordance with various embodiments described herein.

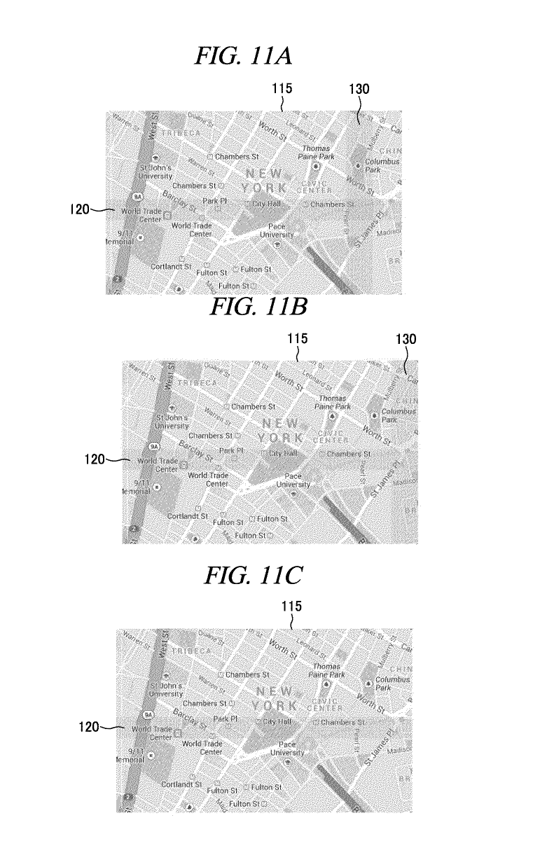

FIGS. 11A to 11C show still another example of a highlighting user interface, in accordance with various embodiments described herein.

As depicted in FIG. 11A, first highlighting bar 120 and second highlighting bar 130 may be displayed on image 115. In some embodiments, image 115 may be a non-scrollable image. Further, apparatus 105 may be configured to move second highlighting bar 130 laterally, i.e., to the left or to the right, on image 115, when apparatus 105 receives an input to instruct a movement of second highlighting bar 130. So, second highlighting bar 130 may be positioned at a boundary on the left side or the right side of image 115. As depicted in the example of FIG. 11B, second highlighting bar 130 may be positioned at the boundary on the right side of image 115. Further, apparatus 105 may be configured to remove second highlighting bar 130 from image 115 when apparatus 105 receives the input to instruct second highlighting bar 130 which is positioned at the boundary on the left side of image 115 to go further to the left. Alternatively, apparatus 105 may be configured to remove second highlighting bar 130 from image 115 when apparatus 105 receives the input to instruct second highlighting bar which is positioned at the boundary on the right side of image 115 to go further to the right. For example, as depicted in FIG. 11C, second highlighting bar 130 may be removed from image 115 when apparatus 105 receives the input to instruct second highlighting bar 130, which may be positioned at the boundary on the right side of image 115 to move even further beyond the boundary.

Thus, FIGS. 11A to 11C show still another example of a highlighting user interface, in accordance with various embodiments described herein.

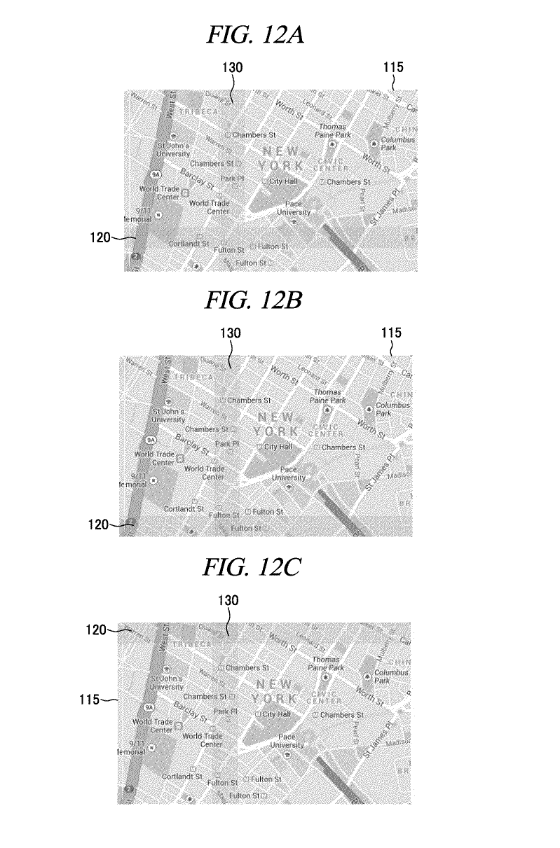

FIGS. 12A to 12C show still another examples of a highlighting user interface, in accordance with various embodiments described herein.

As depicted in FIG. 12A, first highlighting bar 120 and second highlighting bar 130 may be displayed on image 115. In some embodiments, image 115 may be a non-scrollable image. Further, apparatus 105 may be configured to move first highlighting bar 120 vertically, i.e., up or down, on image 115, when apparatus 105 receives an input to instruct a movement of first highlighting bar 120. So, first highlighting bar 120 may be positioned at an upper boundary or a lower boundary of image 115. For example, as depicted in FIG. 12B, first highlighting bar 120 may be positioned at a lower boundary of image 115. Further, apparatus 105 may be configured to move first highlighting bar 120 from the upper boundary of image 115 to the lower boundary of image 115, when apparatus 105 receives the input to instruct first highlighting bar 120, which may be positioned at the upper boundary of image 115 to go up beyond the upper boundary. Alternatively, apparatus 105 may be configured to move first highlighting bar 120 from the lower boundary of image 115 to the upper boundary of image 115 when apparatus 105 receives the input to instruct first highlighting bar 120 which is positioned at the lower boundary of image 115 to go down below the lower boundary. For example, as depicted in FIG. 12C, first highlighting bar 120 may jump from the lower boundary of image 115 to the upper boundary of image 115, when apparatus 105 receives the input to instruct first highlighting bar 120, which may be positioned at the lower boundary of image 115 to move further below the lower boundary.

Thus, FIGS. 12A to 12C show still another example of a highlighting user interface, in accordance with various embodiments described herein.

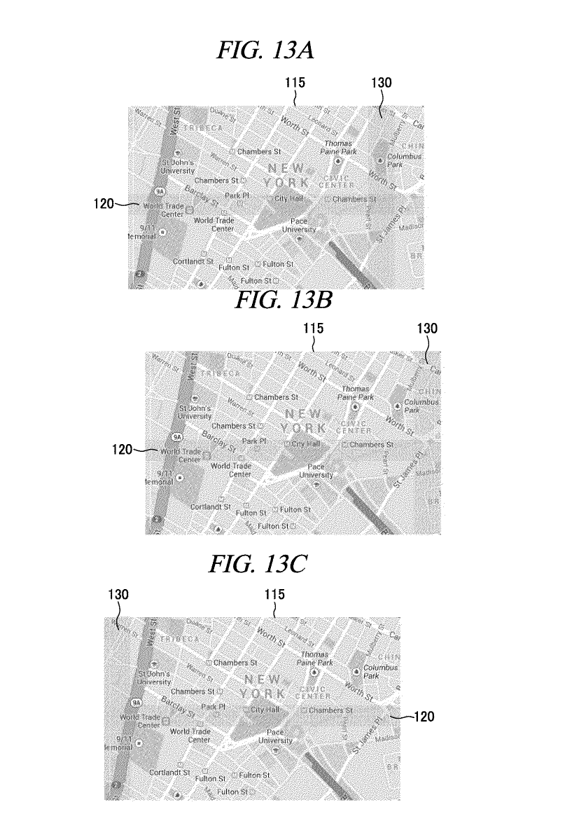

FIGS. 13A to 13C show still another example of a highlighting user interface, in accordance with various embodiments described herein.

As depicted in FIG. 13A, first highlighting bar 120 and second highlighting bar 130 may be displayed on image 115. In some embodiments, image 115 may be a non-scrollable image. Further, apparatus 105 may be configured to move second highlighting bar 130 to the right or to the left on image 115 when apparatus 105 receives an input to instruct a movement of second highlighting bar 130. So, second highlighting bar 130 may be positioned at the boundary on the right side or the left side of image 115. For example, as depicted in FIG. 13B, second highlighting bar 130 may be positioned at the boundary on the right side of image 115. Further, apparatus 105 may be configured to move second highlighting bar 130 from the boundary on the right side of image 115 to the boundary on the left side of image 115 when apparatus 105 receives the input to instruct second highlighting bar 130, which may be positioned on the boundary on the right side of image 115 to go to the right beyond the boundary. Alternatively, apparatus 105 may be configured to move second highlighting bar 130 from the boundary on the left side of image 115 to the boundary on the right side of image 115 when apparatus 105 receives the input to instruct second highlighting bar 130, which may be positioned on the boundary on the left side of image 115 to go to the left beyond the boundary. For example, as depicted in FIG. 13C, second highlighting bar 130 may be moved from the boundary on the right side of image 115 to the boundary on the left side of image 115 when apparatus 105 receives the input to instruct second highlighting bar 130, which may be positioned on the boundary on the right side of image 115 to move to the right beyond the boundary.

Thus, FIGS. 13A to 13C show still another example of a highlighting user interface, in accordance with various embodiments described herein.

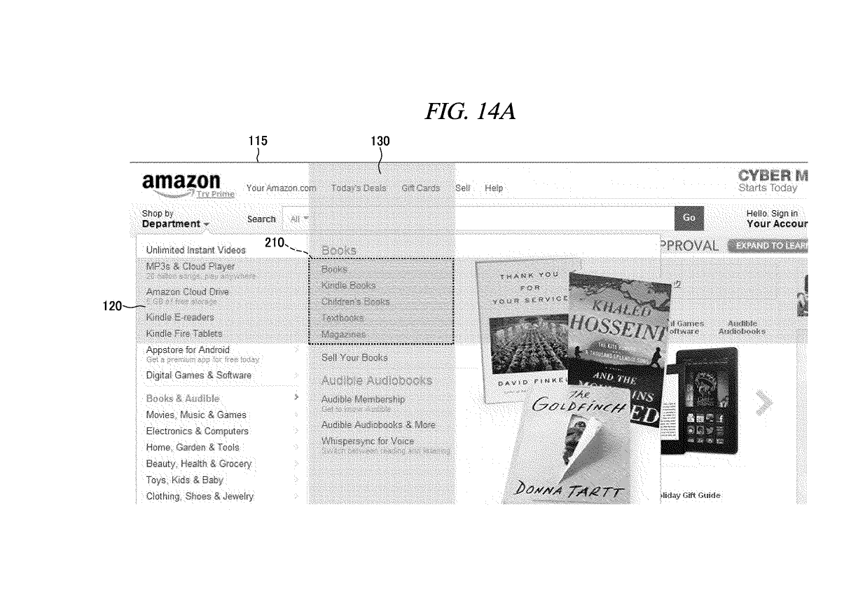

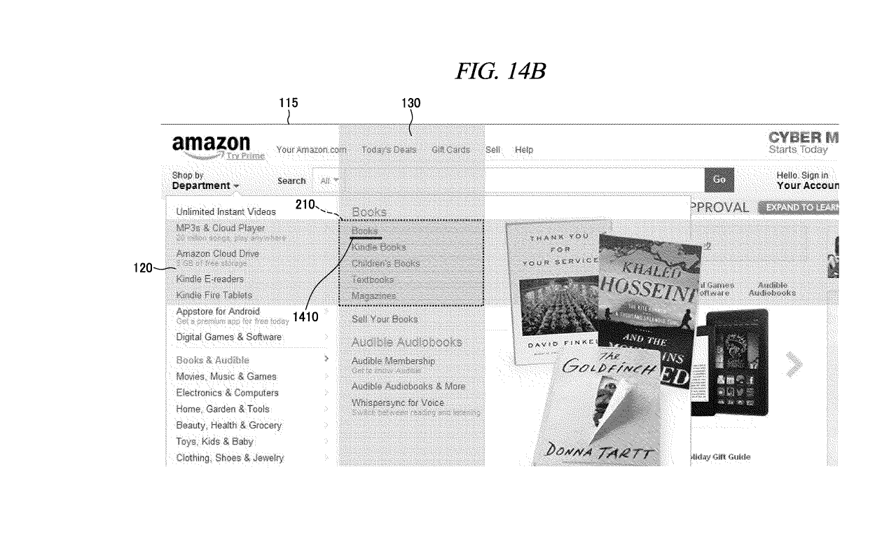

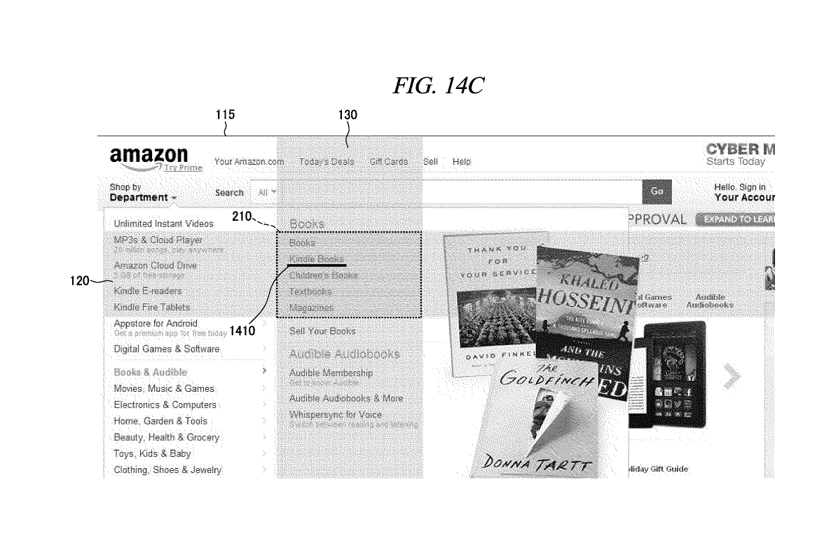

FIGS. 14A to 14C show still another examples of a highlighting user interface, in accordance with various embodiments described herein. Apparatus 105 may be configured to display first highlighting bar 120 and second highlighting bar 130 on image 115. For example, but not as a limitation, as depicted in FIG. 14A, image 115 may include a web page. Further, as depicted in FIG. 14A, overlap area 210 in which a portion of first highlighting bar 120 and a portion of second highlighting bar 130 overlap may be determined and/or fixed, when apparatus 105 receives, from end device 110, an input to select overlap area 210.

Further, in some embodiments, apparatus 105 may be configured to display an indicator 1410 to point to a representation of an object within determined and/or fixed overlap area 210 when apparatus 105 receives the input after overlap area 210 is determined and/or fixed. For example, as depicted in FIG. 14B, indicator 1410 may be displayed while indicating a first object (e.g., a hyperlink) positioned at an upper portion of overlap area 210.

Further, apparatus 105 may be configured to move indicator 1410 to point to a representation of another object within determined and/or fixed overlap area 210, when apparatus 105 receives, from end device 110, an input to instruct a movement of indicator 1410. For example, apparatus 105 may move indicator 1410 down when apparatus 105 receives, from end device 110, the input to instruct indicator 1410 to move down. So, as depicted in FIG. 14C, indicator 1410 may indicate a second object positioned below the first object within overlap area 210. Further, apparatus 105 may move indicator 1410 from a representation of an object located in a lower portion within overlap area 210 to a representation of an object located in an upper portion within overlap area 210 when apparatus 105 receives the input to instruct indicator 1410 highlighting to the object in the lower portion to move further down.

Thus, FIGS. 14A to 14C show still another examples of a highlighting user interface, in accordance with various embodiments described herein.

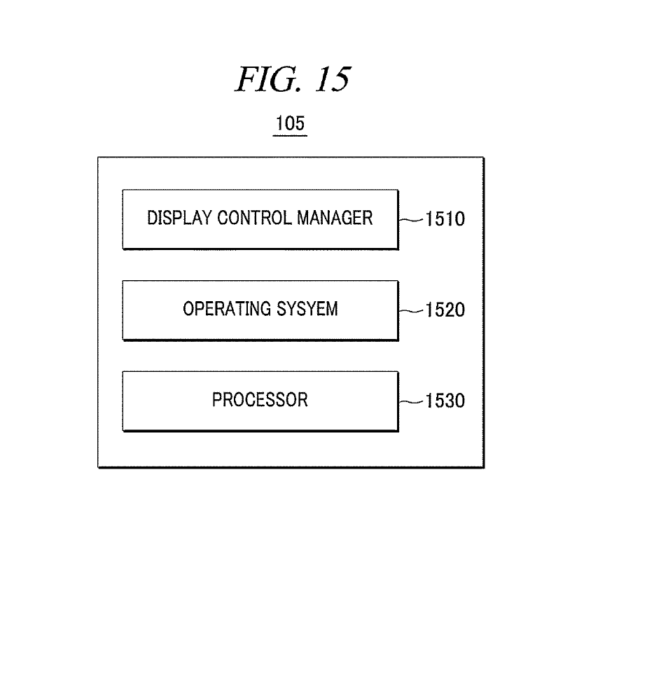

FIG. 15 shows an example configuration of an apparatus 105 by which at least portions of a highlighting user interface may be implemented, in accordance with various embodiments described herein.

As depicted in FIG. 15, apparatus 105 may include a display control manager 1510, an operating system 1520 and a processor 1530. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In some embodiments, display control manager 1510 may be an application adapted to operate on operating system 1520 such that the user interface for an internet protocol television as described herein may be provided. Operating system 1520 may allow display control manager 1510 to manipulate processor 1530 to implement the user interface for an internet protocol television as described herein.

Thus, FIG. 15 shows an example configuration of apparatus 105 by which at least portions of a highlighting user interface may be implemented, in accordance with various embodiments described herein.

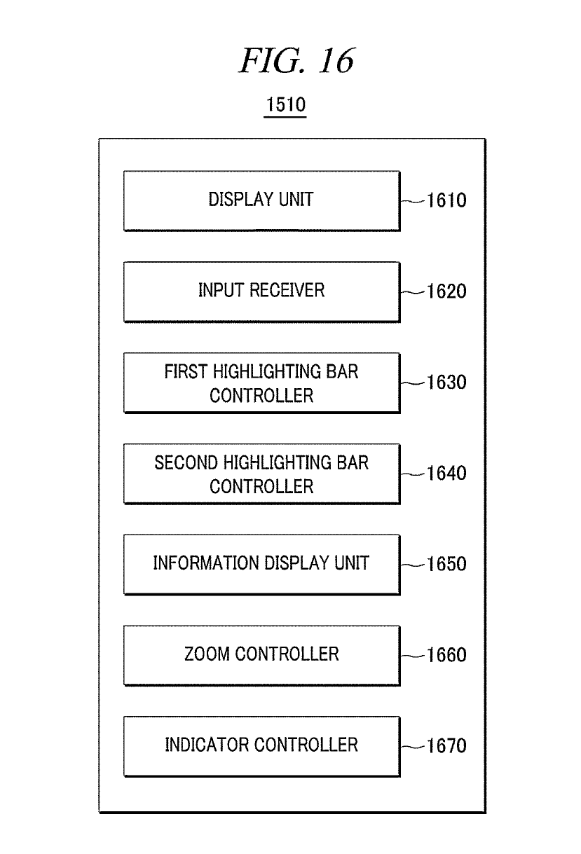

FIG. 16 shows an example configuration of a display control manager 1510 by which at least portions of a highlighting user interface may be implemented, in accordance with various embodiments described herein.

As depicted in FIG. 16, display control manager 1510 may include a display unit 1610, an input receiver 1620, a first highlighting bar controller 1630, a second highlighting bar controller 1640, an information display unit 1650, a zoom controller 1660, and an indicator controller 1670. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof.

Display unit 1610 may be configured to display an image on a display that may be part of, or communicatively coupled to, apparatus 105. Display unit 1610 may be configured to play or reproduce, on the display, internet protocol television content that includes at least one of video-on-demand content, real-time broadcasting content or user interactive content (e.g., games). The displayed image may refer to a frame or a scene included in the played or reproduced internet protocol television content. Further, display unit 1610 may be configured to display a first highlighting bar and a second highlighting bar on the displayed image. For example, the first highlighting bar may be a horizontal highlighting bar and the second highlighting bar may be a vertical highlighting bar.

In some embodiments, display unit 1610 may be further configured to display a representation for each of multiple points of interest (POI) on the displayed image. For example, but not as a limitation, the multiple points of interest may include a hotel, a campsite, a fuel station, a hospital, a bus station, a restaurant, a subway station or any other categories used in navigation systems.

In some embodiments, display unit 1610 may be further configured to display an indicator to point to a representation of an object within an overlap area in which a portion of the first highlighting bar and a portion of the second highlighting bar overlap on the displayed image.

For example, but not as a limitation, the object may refer to a hotel, a campsite, a fuel station, a hospital, a bus station, a restaurant, a subway station or any other categories used in navigation systems or refer to a hyper link or a banner in a web page.

In some embodiments, display unit 1610 may be further configured to scroll the image in a direction that is opposite to a direction of movements of the first highlighting bar, when apparatus 105 receives an input to instruct the first highlighting bar which is positioned at an upper boundary or a lower boundary of the image to go beyond a boundary of the image. Further, display unit 1610 may be further configured to scroll the image in a direction that is opposite to a direction of movements of the second highlighting bar, when apparatus 105 receives an input to instruct the second highlighting bar which is positioned at a boundary on the right side or the left side of the image to go beyond the boundary of the image.

Input receiver 1620 may be configured to receive, from end device 110, at least one of the input to instruct a movement of the first highlighting bar or the input to instruct a movement of the second highlighting bar. Further, input receiver 1620 may be configured to receive, from end device 110, an input to select the overlap area in which a portion of the first highlighting bar and a portion of the second highlighting bar overlap on the displayed image.

First highlighting bar controller 1630 may be configured to move the first highlighting bar up or down on the displayed image, based at least in part on the input to instruct a movement of the first highlighting bar. In some embodiments, first highlighting bar controller 1630 may be configured to move the first highlighting bar up or down on the displayed image in increments of a predetermined distance. For example, but not as a limitation, first highlighting bar controller 1630 may be configured to move the first highlighting bar up or down on the displayed image in increments equal to a height of the first highlighting bar.

In some embodiments, first highlighting bar controller 1630 may be configured to move the first highlighting bar from a representation of a first point of interest to a representation of a second point of interest. That is, the first highlighting bar may jump from the representation of the first point of interest to the representation of the second point of interest on the displayed image.

In some embodiments, first highlighting bar controller 1630 may be configured to move the first highlighting bar from an upper boundary of the image to a lower boundary of the image, when input receiver 1620 receives the input to instruct the first highlighting bar which may be positioned at the upper boundary to go up beyond the upper boundary. Further, first highlighting bar controller 1630 may be configured to move the first highlighting bar from the lower boundary of the image to the upper boundary of the image when input receiver 1620 receives the input to instruct the first highlighting bar, which is positioned at the lower boundary, to go down beyond the lower boundary. That is, the first highlighting bar may jump from the upper boundary of the image to the lower boundary of the image or jump from the lower boundary of the image to the upper boundary of the image.

In some embodiments, first highlighting bar controller 1630 may be configured to remove the first highlighting bar from the image when input receiver 1620 receives the input to instruct the first highlighting bar, which may be positioned at the upper boundary of the image, to go up beyond the upper boundary. Alternatively, first highlighting bar controller 1630 may be configured to remove the first highlighting bar from the image, when input receiver 1620 receives the input to instruct the first highlighting bar, which may be positioned at the lower boundary of the image, to go down beyond the lower boundary.

Second highlighting bar controller 1640 may be configured to move the second highlighting bar laterally, i.e., to the left or to the right, on the displayed image, based at least in part on an input to instruct a movement of the second highlighting bar. In some embodiments, second highlighting bar controller 1640 may be configured to move the second highlighting bar laterally on the displayed image in increments equal to a predetermined distance. For example, but not as a limitation, second highlighting bar controller 1640 may be configured to move the second highlighting bar to the left or to the right on the displayed image in increments equal to a width of second highlighting bar.

In some embodiments, second highlighting bar controller 1640 may be configured to move the second highlighting bar from a representation of a third point of interest to a representation of a fourth point of interest. That is, the second highlighting bar may jump from the representation of the third point of interest to the representation of the fourth point of interest on the displayed image.

In some embodiments, second highlighting bar controller 1640 may be configured to move the second highlighting bar from a boundary on the right side of the image to a boundary on the left side of the image when input receiver 1620 receives the input to instruct the second highlighting bar, which may be positioned at the boundary on the right side of the image, to go to the right beyond the boundary. Further, second highlighting bar controller 1640 may be configured to move the second highlighting bar from a boundary on the left side of the image to a boundary on the right side of the image when input receiver 1620 receives the input to instruct the second highlighting bar, which may be positioned at the boundary on the left side of the image, to go to the left beyond the boundary. That is, the second highlighting bar may jump from the boundary on the right side of the image to the boundary on the left side of the image or jump from the boundary on the left side of the image to the boundary on the right side of the image.

In some embodiments, second highlighting bar controller 1640 may be configured to remove the second highlighting bar from the image when input receiver 1620 receives the input to instruct the second highlighting bar, which may be positioned at the boundary on the right side of the image, to go right beyond the boundary. Alternatively, second highlighting bar controller 1640 may be configured to remove the second highlighting bar from the image when input receiver 1620 receives the input to instruct the second highlighting bar, which may be positioned at the boundary on the left side of the image, to go to the left beyond the boundary.

Information display unit 1650 may be configured to display information associated with the overlap area, based at least in part on the input to select the overlap area, on a display that is part of, or communicatively coupled to, apparatus 105. For example, but not as a limitation, the information associated with the overlap area may include at least one of information regarding a representation of an object within the overlap area (e.g., an image, a symbol, an icon corresponding to the object), information regarding the object (e.g., an address, a name, a telephone number of the object) or a URL associated with the object.

Zoom controller 1660 may be configured to zoom in or zoom out from portions of the displayed image, based at least in part on a display density of multiple points of interest displayed on the image. Zoom controller 1660 may be configured to zoom in on a portion of the image in order to display a predetermined range number of points of interest on the image if more points of interest than the predetermined range number of points of interest are displayed on the image. Alternatively, zoom controller 1660 may be configured to zoom out from a portion of the image in order to display the predetermined range number of points of interest on the image if fewer points of interest than the predetermined range number of points of interest are displayed on the image.

Indicator controller 1670 may be configured to move an indicator displayed within the overlap area from a representation of an object to a representation of another object within the overlap area to point to the representation of another object, when apparatus 105 receives, from end device 110, a moving input that instructs a movement of the indicator.

Thus, FIG. 16 shows an example configuration of display control manager 1510 by which at least portions of a highlighting user interface may be implemented, in accordance with various embodiments described herein.

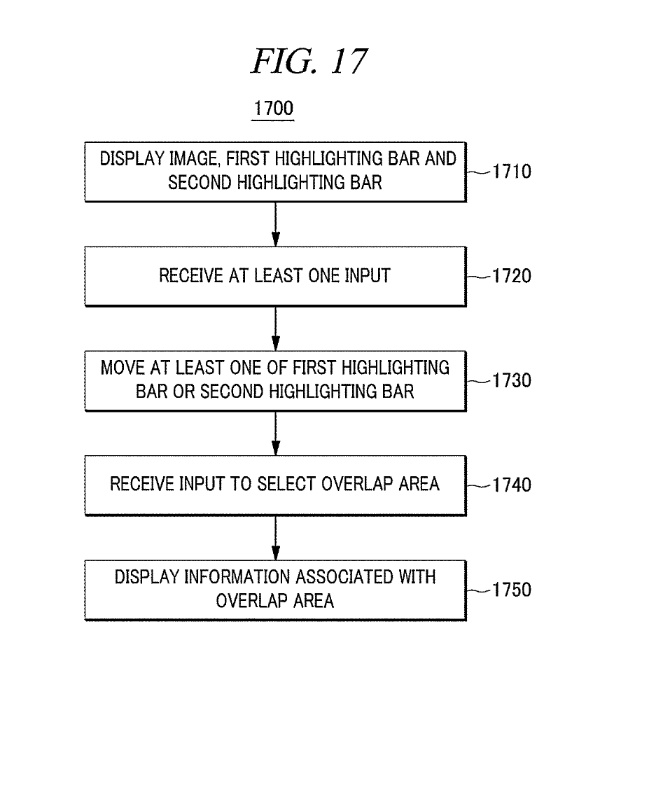

FIG. 17 shows an example processing flow 1700 of operations for implementing at least portions of a highlighting user interface, in accordance with various embodiments described herein. The operations of processing flow 1700 may be implemented in apparatus 105 including display unit 1610, input receiver 1620, first highlighting bar controller 1630, second highlighting bar controller 1640, information display unit 1650, zoom controller 1660, and indicator controller 1670, as illustrated in FIG. 16. An example process may include one or more operations, actions, or functions as illustrated by one or more blocks 1710, 1720, 1730, 1740 and/or 1750. Although illustrated as discrete blocks, various blocks may be divided into additional blocks, combined into fewer blocks, or eliminated, depending on the desired implementation. Processing may begin at block 1710.

Block 1710 (Display Image, First Highlighting bar and Second Highlighting bar) may refer to display unit 1610 displaying an image, a first highlighting bar and a second highlighting bar on a display that may be part of, or communicatively coupled to, apparatus 105. Display unit 1610 may play or reproduce, on the display, internet protocol television content that includes at least one of video-on-demand content, real-time broadcasting content or user interactive content (e.g., games). The displayed image may refer to a frame or a scene included in the played or reproduced internet protocol television content. For example, the first highlighting bar may be a horizontal highlighting bar and the second highlighting bar may be a vertical highlighting bar. Processing may proceed from block 1710 to block 1720.

Block 1720 (Receive At Least One Input) may refer to input receiver 1620 receiving at least one of an input to instruct a movement of the first highlighting bar or an input to instruct a movement of the second highlighting bar. Processing may proceed from block 1720 to block 1730.

Block 1730 (Move At Least One of First Highlighting bar or Second Highlighting bar) may refer to first highlighting bar controller 1630 moving the first highlighting bar and/or second highlighting bar controller 1640 moving the second highlighting bar. First highlighting bar controller 1630 may move the first highlighting bar up or down on the displayed image, based at least in part on the input received at block 1720. Further, second highlighting bar controller 1640 may move the second highlighting bar laterally on the displayed image, based at least in part on the input received at block 1720. Processing may proceed from block 1730 to block 1740.

Block 1740 (Receive Input to Select Overlap Area) may refer to input receiver 1620 receiving an input to select an overlap area in which a portion of the first highlighting bar and a portion of the second highlighting bar overlap on the displayed image. Processing may proceed from block 1740 to block 1750.

Block 1750 (Display Information Associated with Overlap Area) may refer to information display unit 1650 displaying information associated with the overlap area selected at block 1740, based at least in part on the received input, on a display that may be part of, or communicatively coupled to, apparatus 105. For example, but not as a limitation, the information associated with the overlap area may include at least one of information regarding a representation of an object within the overlap area (e.g., an image, a symbol, an icon corresponding to the object), information regarding the object (e.g., an address, a name, a telephone number of the object) or a URL associated with the object.

Thus, FIG. 17 shows an example processing flow 1700 of operations for implementing at least portions of a highlighting user interface, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

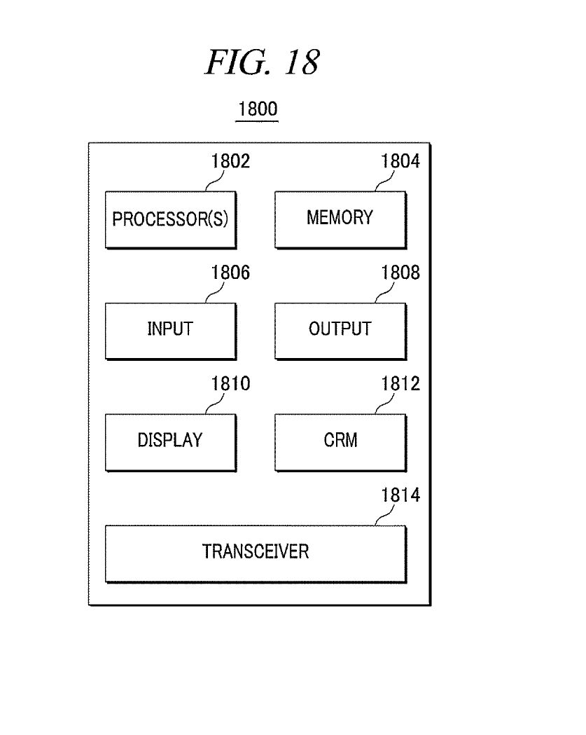

FIG. 18 shows an illustrative computing embodiment, in which any of the processes and sub-processes of a highlighting user interface may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 1800 may typically include, at least, one or more processors 1802, a system memory 1804, one or more input components 1806, one or more output components 1808, a display component 1810, a computer-readable medium 1812, and a transceiver 1814.

Processor 1802 may refer to, e.g., a microprocessor, a microcontroller, a digital signal processor, or any combination thereof.

Memory 1804 may refer to, e.g., a volatile memory, non-volatile memory, or any combination thereof. Memory 1804 may store, therein, an operating system, an application, and/or program data. That is, memory 1804 may store executable instructions to implement any of the functions or operations described above and, therefore, memory 1804 may be regarded as a computer-readable medium.

Input component 1806 may refer to a built-in or communicatively coupled keyboard, touch screen, or telecommunication device. Alternatively, input component 1806 may include a microphone that is configured, in cooperation with a voice-recognition program that may be stored in memory 1804, to receive voice commands from a user of computing device 1800. Further, input component 1806, if not built-in to computing device 1800, may be communicatively coupled thereto via short-range communication protocols including, but not limitation, radio frequency or Bluetooth.

Output component 1808 may refer to a component or module, built-in or removable from computing device 1800, which is configured to output commands and data to an external device.

Display component 1810 may refer to, e.g., a solid state display that may have touch input capabilities. That is, display component 1810 may include capabilities that may be shared with or replace those of input component 1806.

Computer-readable medium 1812 may refer to a separable machine readable medium that is configured to store one or more programs that embody any of the functions or operations described above. That is, computer-readable medium 1812, which may be received into or otherwise connected to a drive component of computing device 1800, may store executable instructions to implement any of the functions or operations described above. These instructions may be complimentary or otherwise independent of those stored by memory 1804.

Transceiver 1814 may refer to a network communication link for computing device 1800, configured as a wired network or direct-wired connection. Alternatively, transceiver 1814 may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. An apparatus, comprising:
a display unit configured to:
display an image, and
display a first highlighting bar and a second highlighting bar on the displayed image;
a first highlighting bar controller configured to move the first highlighting bar up or down on the displayed image, based at least in part on a first input instructing a movement of the first highlighting bar;
a second highlighting bar controller configured to move the second highlighting bar to left or right on the displayed image, based at least in part on a second input instructing a movement of the second highlighting bar; and
an information display unit configured to display information associated with an overlap area in which the first highlighting bar and the second highlighting bar overlap, based at least in part on a third input to select the overlap area.

2. The apparatus of claim 1, further comprising:
an input receiver configured to receive at least one of the first input, the second input or the third input.

3. The apparatus of claim 1,
wherein the first highlighting bar is a horizontal highlighting bar, and
wherein the second highlighting bar is a vertical highlighting bar.

4. The apparatus of claim 1, wherein the display unit is further configured to display a representation for each of plurality of points of interest on the displayed image,
wherein the first highlighting bar controller is further configured to move the first highlighting bar from a representation of a first point of interest to a representation of a second point of interest, and
wherein the second highlighting bar controller is further configured to move the second highlighting bar from a representation of a third point interest to a representation of a fourth point of interest.

5. The apparatus of claim 4, further comprising:
a zoom controller configured to zoom in or out the displayed image based at least in part on a display density of the plurality of points of interest on the displayed image.

6. The apparatus of claim 1, wherein the information associated with the overlap area includes at least one of information regarding a representation of an object within the overlap area or a URL associated with the object at the overlap area.

7. The apparatus of claim 6,
wherein the display unit is further configured to display an indicator to point to the representation of the object within the overlap area, and
wherein the apparatus further comprises:
an indicator controller configured to move the indicator to point to a representation of another object within the overlap area.

8. The apparatus of claim 1, wherein the display unit is further configured to scroll the displayed image in a direction that is opposite to a direction of the movements of the first highlighting bar and the second highlighting bar.

9. The apparatus of claim 1, wherein the first highlighting bar controller is further configured to move the first highlighting bar from a lower boundary of the displayed image to an upper boundary of the displayed image.

10. The apparatus of claim 1, wherein the first highlighting bar controller is further configured to remove the first highlighting bar from the displayed image.

11. A computer-readable storage medium having thereon computer-executable instructions that, in response to execution, cause one or more processors corresponding to an apparatus to perform operations, comprising:
displaying an image;
displaying a first highlighting bar and a second highlighting bar on the displayed image;
moving the first highlighting bar up or down on the displayed image, based at least in part on a first input instructing a movement of the first highlighting bar;
moving the second highlighting bar to left or right on the displayed image, based at least in part on a second input instructing a movement of the second highlighting bar; and
displaying information associated with an overlap area in which the first highlighting bar and the second highlighting bar overlap, based at least in part on a third input to select the overlap area.

12. The computer-readable storage medium of claim 11, wherein the operations further comprise:
receiving at least one of the first input, the second input or the third input.

13. The computer-readable storage medium of claim 11,
wherein the first highlighting bar is a horizontal highlighting bar, and
wherein the second highlighting bar is a vertical highlighting bar.

14. The computer-readable storage medium of claim 11,
wherein the operations further comprise:
displaying a representation for each of plurality of points of interest on the displayed image,
wherein the moving of the first highlighting bar includes:
moving the first highlighting bar from a representation of a first point of interest to a representation of a second point of interest, and
wherein the moving of the second highlighting bar includes:
moving the second highlighting bar from a representation of a third point of interest to a representation of a fourth point of interest.

15. The computer-readable storage medium of claim 14, wherein the operations further comprise:
zooming in or out the displayed image based at least in part on a display density of the plurality of points of interest on the displayed image.

16. The computer-readable storage medium of claim 11, wherein the information associated with the overlap area includes at least one of information regarding an object at the overlap area or a URL associated with the object at the overlap area.

17. The computer-readable storage medium of claim 11, wherein the operations further comprise:
scrolling the displayed image to a direction that is opposite to the movements of the first highlighting bar and the second highlighting bar.

18. A method performed under control of an apparatus, comprising:
displaying an image;
displaying a first highlighting bar and a second highlighting bar on the displayed image;
moving the first highlighting bar up or down on the displayed image, based at least in part on a first input instructing a movement of the first highlighting bar;
moving the second highlighting bar laterally on the displayed image, based at least in part on a second input instructing a movement of the second highlighting bar; and
displaying information associated with the overlap area in which the first highlighting bar and the second highlighting bar overlap, based at least in part on a third input to select the overlap area.

19. The method of claim 18, further comprising:
receiving at least one of the first input, the second input or the third input.

20. The method of claim 18, further comprising:
displaying a representation for each of a plurality of points of interest on the displayed image,
wherein the moving of the first highlighting bar includes:
moving the first highlighting bar from a representation of a first point of interest to a representation of a second point of interest, and
wherein the moving of the second highlighting bar includes:
moving the second highlighting bar from a representation of a third point of interest to a representation of a fourth point of interest.
